(19) United States
(12) Patent Application Publication
(10) Pub. No.: US 2008/0110705 A1
(43) Pub. Date: May 15, 2008

(54) Braking device for a power winch

(76) Inventor: Shih Jyi Huang, Taipei (TW)

Correspondence Address: BACON & THOMAS, PLLC, 625 SLATERS LANE, FOURTH FLOOR, ALEXANDRIA, VA, 22314, US

(21) Appl. No.: 11/595,982

(22) Filed: Nov. 13, 2006

(51) Int. Cl. B60T 13/04

(52) U.S. Cl. 188/166

(57) ABSTRACT

A braking device for a power winch includes a first driving block having one side fixed with two symmetrical posts having their outer ends respectively cut with a stepped notch and having two accommodating spaces formed between them. A second driving block has one side secured with two symmetrical posts respectively positioned in the accommodating spaces of the first driving block and respectively having their outer ends provided with a stepped notch. A braking spring is fitted around the outer circumference of the posts of the first and the second driving block, having the opposite end respectively formed with a hook end bent inward to be respectively moved in the notches of the first or the second driving block. When the motor is electrically disconnected, the elastic wires of the braking spring are forced by the driving block to expand outward and carry out braking.

### BACKGROUND OF THE INVENTION

1. Field of the Invention

This invention relates to a braking device for a power winch, particularly to one assembled in the transmission course of a power winch, able to carry out braking promptly.

2. Description of the Prior Art

A power winch, also called as a hoisting winder, is a hoisting apparatus able to retract or release steel cables for slinging up or lowering down heavy loads. A power winch can be positioned on a high building for slinging or lowering goods, or assembled on a jeep or a cross-country vehicle for dragging other vehicles or for rescuing people. A power winch must be provided with a braking device so that when power supply is cut off (whether by pressing a stop key or due to unexpected electric stoppage), the power winch can be stopped operating immediately. A conventional braking device for a power winch, as disclosed in a U.S. Pat. No. 6,520,486, titled “Braking Device For Motive Winch”, which was devised by the inventor of this invention, is comparatively complicated in structure and only applicable to a power winch that is capable of carrying comparatively heavy loads, but inapplicable to a power winch that is small in size and unable to carry heavy loads.

### SUMMARY OF THE INVENTION

The objective of the invention is to offer a braking device for a power winch, which is installed in the transmission course of a power winch and able to carry out braking promptly.

The braking device for a power winch in the present invention includes a first driving block having one side fixed thereon with two symmetrical posts extending outward vertically and having their outer ends respectively cut with a stepped notch, with two accommodating spaces formed between the two posts. A second driving block has one side secured with two symmetrical posts extending outward vertically to be respectively positioned in the two accommodating spaces of the first driving block but not completely contacting with the two posts of the first driving block. The two posts of the second driving block have their outer ends respectively formed with a stepped notch. A braking spring is fitted around the outer circumference of the posts of the first and the second driving block and has its opposite ends respectively formed with an engage end bent inward and having an angular difference formed between them. Thus, during operating, the two engage ends of the braking spring can be respectively and optionally engaged in the notches of the posts of the first and the second driving block to let the spring wires of the braking spring driven by the first or the second driving block to shrink inward or expand outward. By so designing, when the motor is started to rotate clockwise or counterclockwise, the spring wires of the braking spring will be pushed by the first or the second driving block to shrink inward, and at this time the braking device becomes unable to carry out braking and hence heavy loads can be slung up or lowered down smoothly. When the motor is electrically disconnected, the spring wires of the braking spring will be forced by the first and the second driving block to expand outward and promptly carry out braking.

The braking device for a power winch in the present invention can be installed in the interior of the cable drum of a power winch, or disposed between the motor and the reduction gear set of the power winch. In addition, an abrasion-resistant bushing ring can be firmly secured on the inner annular wall of the cable drum and positioned at the coupling portion of the first and the second driving block. Moreover, the braking spring can be fitted in a holding member, which has its outer end held in positioned by a compression spring.

### BRIEF DESCRIPTION OF DRAWINGS

This invention will be better understood by referring to the accompanying drawings, wherein:

FIG. 1 is a cross-sectional view of a first preferred embodiment of a braking device for a power winch in the present invention;

FIG. 2 is an exploded perspective view of the first preferred embodiment of the braking device for a power winch in the present invention;

FIG. 3 is a partial magnified view of FIG. 2;

FIG. 4 is a partial magnified cross-sectional view of the first preferred embodiment of the braking device for a power winch in a non-braking condition in the present invention;

FIG. 5 is a partial magnified cross-sectional view of the first preferred embodiment of the braking device for a power winch in a braking condition in the present invention;

FIG. 6 is a cross-sectional view of a second preferred embodiment of a braking device for a power winch in the present invention;

FIG. 7 is a cross-sectional view of a third preferred embodiment of a braking device for a power winch in the present invention;

FIG. 8 is an exploded perspective view of the third preferred embodiment of the braking device for a power winch in the present invention;

FIG. 9 is a partial magnified view of FIG. 8;

FIG. 10 is a partial magnified view of the third preferred embodiment of the braking device for a power winch in a non-braking condition in the present invention; and

FIG. 11 is a partial magnified view of the third preferred embodiment of the braking device for a power winch in a braking condition in the present invention.

### DETAILED DESCRIPTION OF THE PREFERRED EMBODIMENT

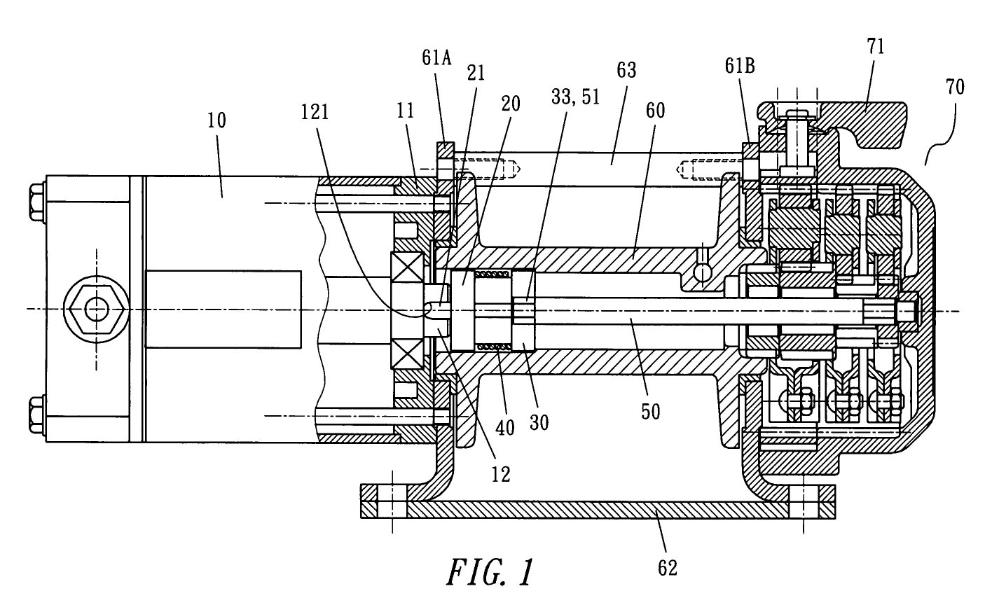

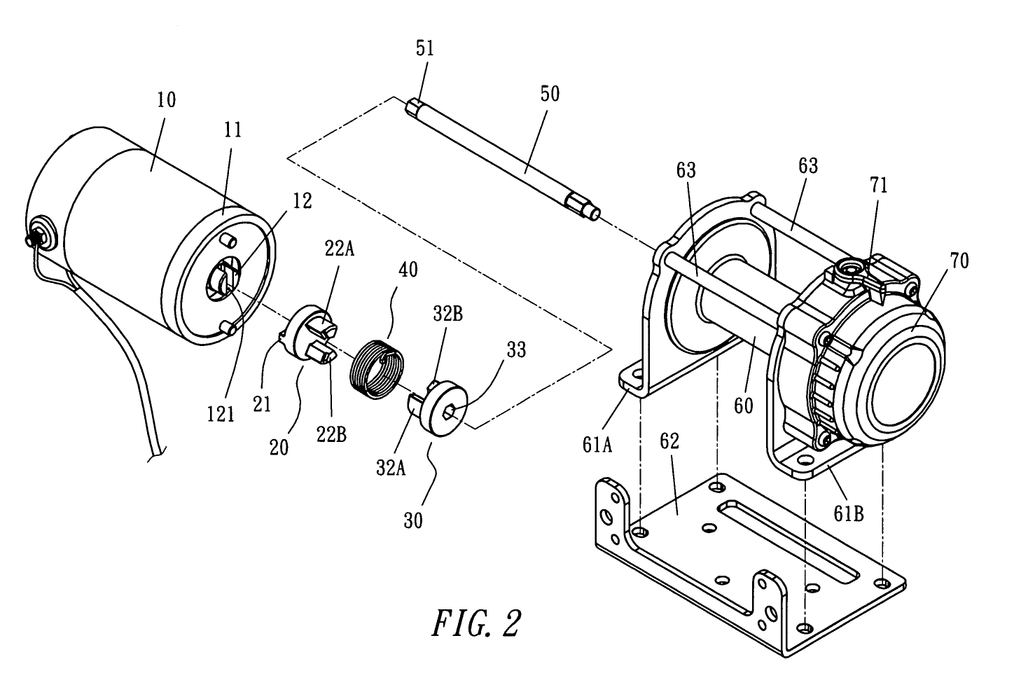

A first preferred embodiment of a braking device installed in the interior of the cable drum of a power winch in the present invention, as shown in FIGS. 1, 2 and 3, includes a motor 10, a first driving block 20, a second driving block 30, a braking spring 40, a spindle 50, a cable drum 60 and a reduction gear set 70 as main components combined together.

The motor 10 fixed with a motor holder 11 has its rotating shaft 12 inserted out of one side of the motor holder 11 and having its outer end formed with a notch 121.

The first driving block 20 has one side provided with a projection 21 to be engaged in the notch 121 of the rotating shaft 12 and the other side fixed thereon with two symmetrical posts 22A, 22B extending outward vertically and having their outer ends respectively cut with a stepped notch 22A1, 22B1, with two accommodating spaces 23 formed between the two posts 22A, 22B.

The second driving block 30 has one side disposed with two symmetrical posts 32A, 32B extending outward vertically and facing the posts 22A, 22B of the first driving block 20. The two posts 32A, 32 B of the second driving block 30 are respectively positioned in the two accommodating spaces 23 of the first driving block 20 but not completely contacting with the two posts 22A, 22B of the first driving block 20. The two posts 32A, 32B of the second driving block 30 have their outer ends respectively cut with a stepped notch 32A1, 32B1, and the second driving block 30 further has the other side bored with an angular slot 33 in the center.

The braking spring 40 is fitted around the outer circumference of the four posts 22A, 22B, 32A, 32B of the first and the second driving blocks 20, 30, as shown in FIG. 1. The braking spring 40 has its opposite ends respectively formed with a hook end 41, 42 bent inward and having an angular difference (120 degrees for instance) formed between them, so that when driven by different members and in different directions, the two hook ends 41, 42 of the braking spring 40 can be respectively and optionally engaged in the notches 22A1, 22B1, 32A1, 32B1 of the first and the second driving block 20, 30. Thus, the elastic wires of the braking spring 40 can be driven by the first driving block 20 or by the second driving block 30 to shrink inward or expand outward.

The spindle 50 has one end formed with an angular head 51 to be firmly inserted and positioned in the angular slot 33 of the second driving block 30, and the other end inserted through the cable drum 60 and secured in the interior of the reduction gear set 70. Thus, the first driving block 20, the second driving block 30, the braking spring 40, the spindle 50 and the motor 10 are connected together in series.

The cable drum 60 has one lower side provided with a fixing base 61A to be locked together with the motor holder 11 and the other lower side provided with another fixing base 61B to be combined with the reduction gear set 70, which has its upper side disposed with an engaging-and-disengaging rod 71. Further, the cable drum 60 has its two fixing bases 61A, 61B firmly mounted on a bottom pedestal 62 and has its upper side fixed with spacing rods 63 for fixing the distance between the two fixing bases 61A and 62B. The bottom pedestal 62 also enables the whole power winch to be placed on a flat surface with great stability.

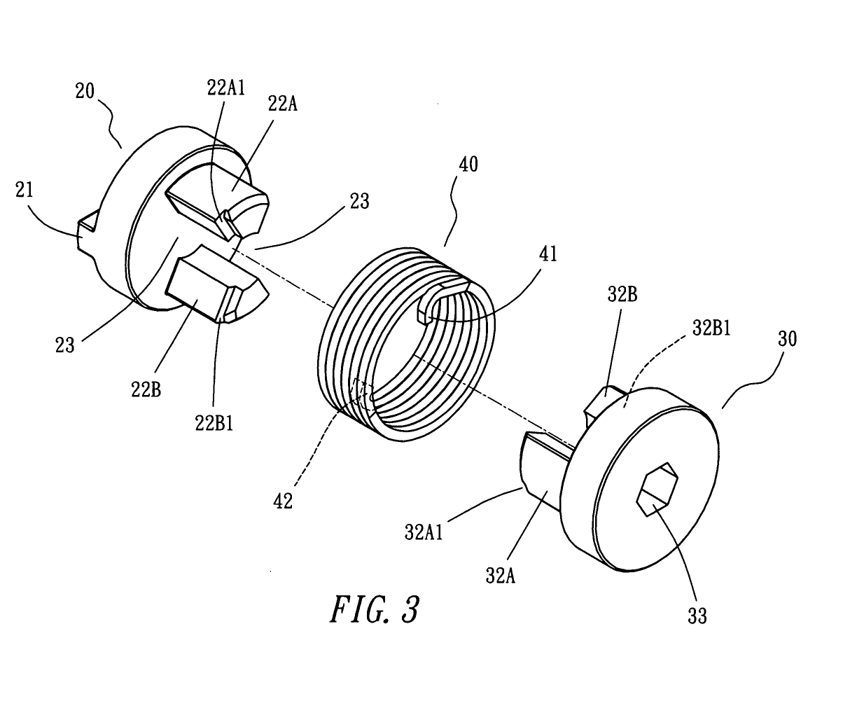

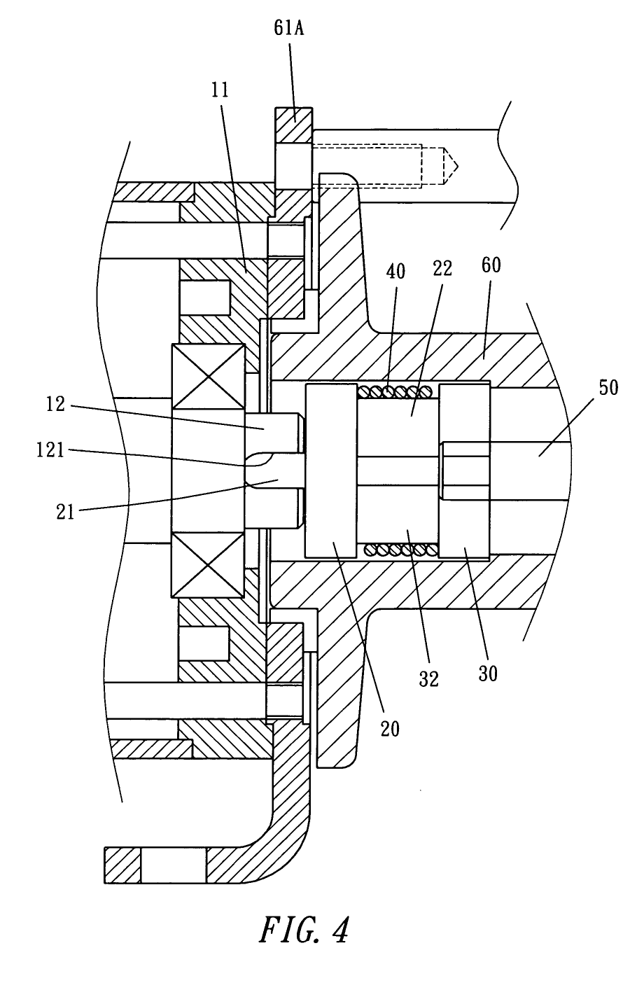

In using, as shown in FIGS. 3 and 4, when the motor 10 is started to rotate clockwise, that is, when the steel cables are released for lowering heavy loads, The first driving block 20 will be driven to rotate and the hook end 41 of the braking spring 40 will be moved in the notch 22A1 of the post 22A of the first driving block 20. Simultaneously, both the post 22A of the first driving block 20 and the hook end 41 of the braking spring 40 will push against the post 32A of the second driving block 32 to move, while the post 22B of the first driving block 20 will push against the post 32B of the second driving block 30 to shift. When the motor 10 is started to rotate counterclockwise, that is, when the steel cables are retracted for slinging up the heavy loads, the first driving block 20 will be driven to rotate and have its post 22B pushing against the post 32A of the second driving block 30 to shift, and simultaneously the hook end 42 of the braking spring 40 will be engaged in the notch 32A1 of the post 32 of the second driving block 30 and actuated to move. In the two ways of operation mentioned above, the inner sides of the two engage ends 41, 42 of the braking spring 40 are respectively pushed by the two posts 22A, 22B of the first driving block 20 to make the elastic wires of the braking spring 40 shrink inward to form a gap between the braking spring 40 and the inner wall of the cable drum 60, rendering the braking device unable to carry out braking and enabling heavy loads able to be slung up or lowered down smoothly.

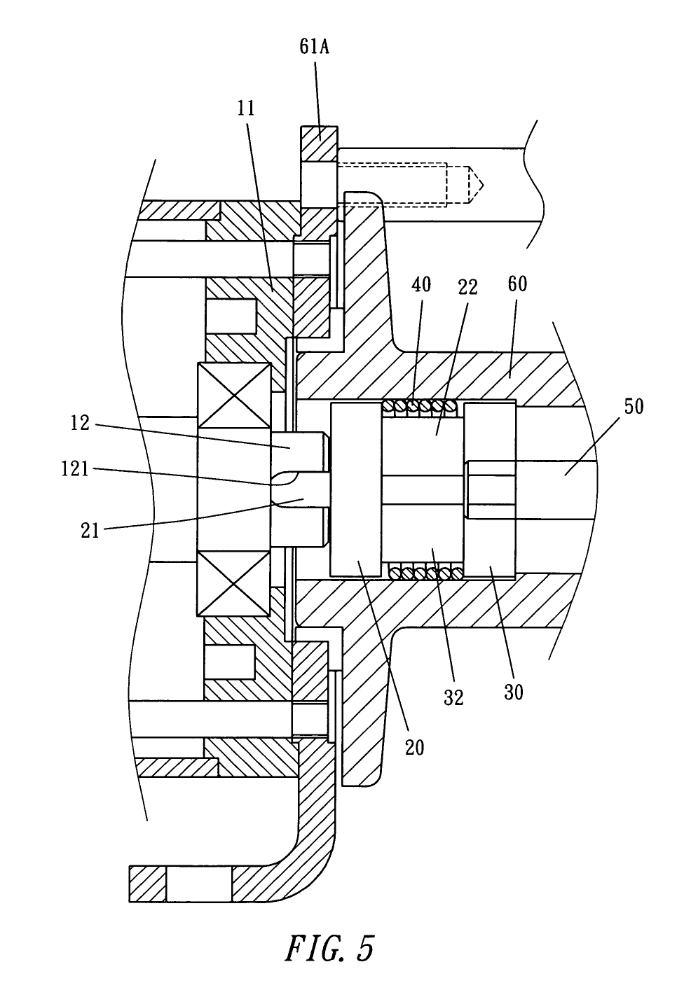

Referring to FIGS. 3 and 5, when the motor 10 is electrically disconnected (either by pressing a stop key or due to unexpected electric stoppage), owing to an downward pulling force of the heavy loads hung on the steel cable, the second driving block 30 will be actuated to rotate by a force coming from the cable drum 60, and the hook end 42 of the braking spring 40 will instantly be moved in the notch 32A1 of the post 32A of the second driving block 30. Simultaneously, both the post 32A of the second driving block 30 and the hook end 42 of the braking spring 40 will push against the post 22B of the first driving block 20 to move, while the post 32B of the second driving block 30 will push against the post 22A of the first driving block 20 to shift. In the operation mentioned above, the outer side of the hook end 42 of the braking spring 40 is pushed by the post 32A of the second driving block 30; therefore, the elastic wires of the braking spring 40 will be forced to expand outward and instantly contact with the inner wall of the cable drum 60 to produce frictional function and carry out braking.

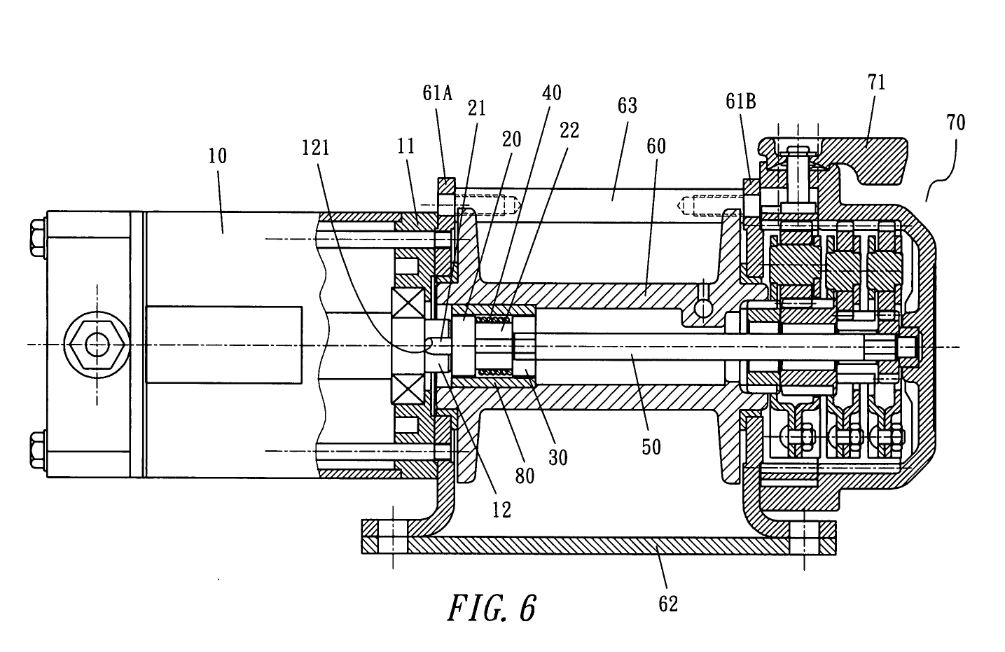

A second preferred embodiment of a braking device for a power winch in the present invention, as shown in FIG. 6, has almost the same structure as that described in the first preferred embodiment, except that an abrasion-resistant bushing ring 80 is additionally secured on the inner annular wall of the cable drum 60 so that the braking spring 40 can directly contact with the bushing ring 80 for carrying out braking, able to reduce wear of the inner wall of the cable drum 60.

Evidently, the braking device in the first and the second preferred embodiment is positioned between the motor and the actuating end of the spindle and received in the inner space of the cable drum, able to minify the size of the whole power winch.

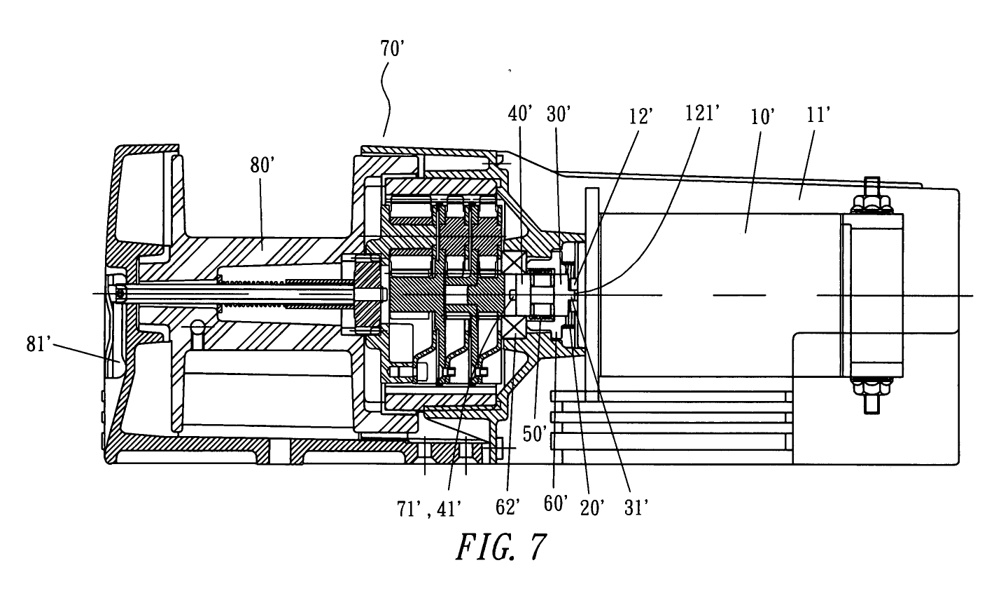

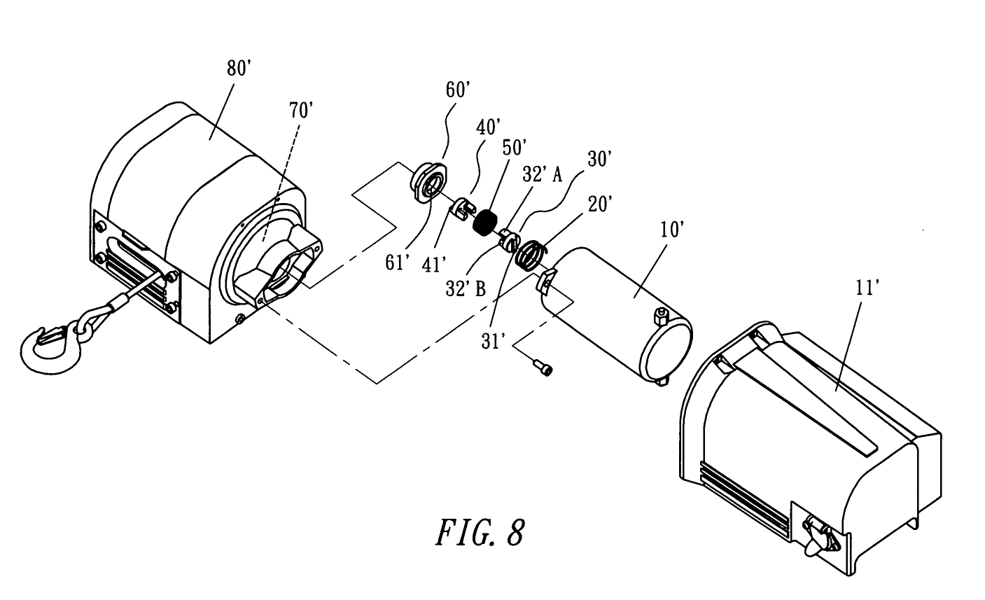

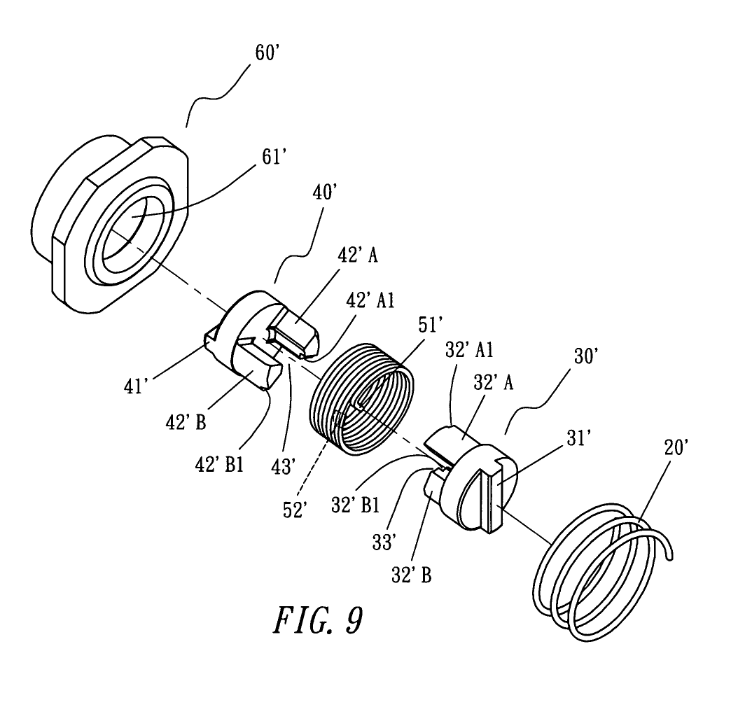

A third preferred embodiment of a braking device for a power winch in the present invention, as shown in FIGS. 7-9, is to have the braking device installed between the motor and the reduction gear set. The braking device of the third preferred embodiment consists of a motor 10′, a compression spring 20′, a first driving block 30′, a second driving block 40′, a braking spring 50′, a holding member 60′, a reduction gear set 70′ and a cable drum 80′ combined together.

The motor 1′ received in a housing 11′ has one end fixed with a rotating shaft 12′ extending outward and having its outer end provided with a notch 121′.

The compression spring 20′ is fitted around the rotating shaft 12′ of the motor 10′.

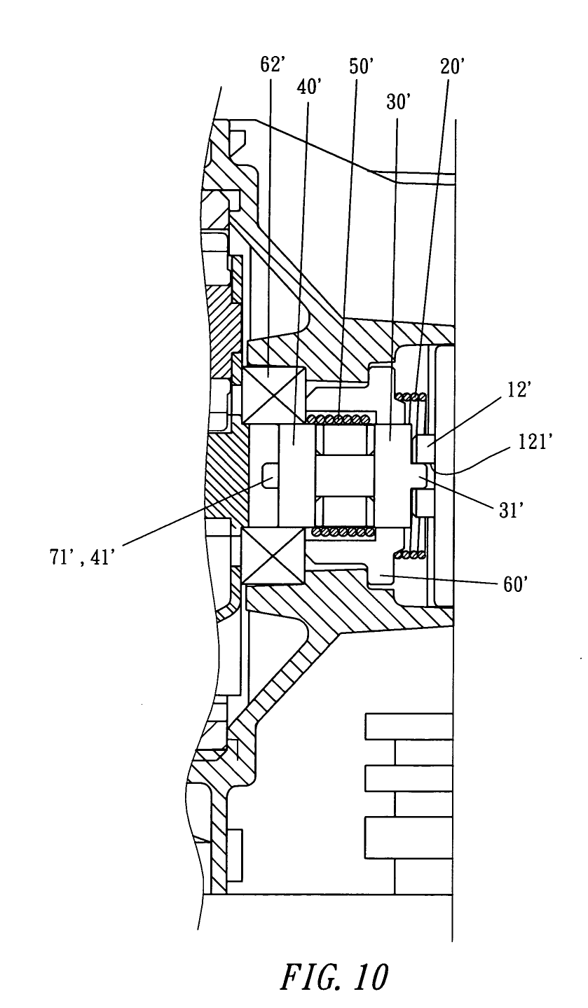

The first driving block 30′ has one side fixed with a projection 31′ to be fitted in the notch 121′ of the rotating shaft 12′ of the motor 10′ so that the motor 10′ can drive the first driving block 30′ to rotate, as shown in FIGS. 7 and 10. The first driving block 30′ has the other side disposed thereon with two symmetrical posts 32′A, 32′B extending outward vertically and having their outer ends respectively cut with a stepped notch 32′A1, 32′B1, with two accommodating spaces 33′ formed between the two posts 32′A, 32′B.

The second driving block 40′ has one side fixed with a projection 41′, and the other side secured thereon with two symmetrical posts 42′A, 42′B extending outward vertically and having their outer ends respectively cut with a stepped notch 42′A1, 42′B1. The two posts 42′A, 42′B of the second driving block 40′ are respectively received in the two accommodating spaces 33′ of the first driving block 30′, but do not completely contact with the two posts 32′A, 32′B of the first driving block 30′.

The braking spring 50′ is fitted around the outer circumference of the four posts 32′A, 32′B, 42′A, 42′B of the first and the second projecting block 30′, 40′, as shown in FIGS. 7 and 10. The opposite ends of the braking spring 50′ are respectively formed with a hook end 51 ′, 52′ bent inward and having an angular difference (120 degrees for instance) formed between them. Thus, when driven by different members and in different directions, the two hook ends 51′, 52′ of the braking spring 50′ can respectively and optionally be moved in the notch 32′A1, 32′B1, 42′A1 or 42′B1 of the first and the second driving block 30′, 40′ to be driven by the first driving block 30′ or by the second driving block 40′ so as to force the elastic wires of the brake spring 50′ to shrink inward or expanded outward.

The holding member 60′ is formed with an accommodating hollow in the center for receiving the braking spring 50′ therein, having its front end held in position by the compression spring 20′ and its rear end resisting against one side of a bearing 62′, as shown in FIGS. 7 and 10.

The reduction gear set 70′ has its outer side formed with a notch 71′ for engaging the projection 41′ of the second driving block 40′ so that the second driving block 40′ can drive the reduction gear set 70′ to operate.

The cable drum 80′ has one side connected with the reduction gear set 70′ and the other side provided with an engaging-and-disengaging control rod 81′ for controlling the cable drum 80′ and the reduction gear set 70′ to be engaged with or disengaged from each other.

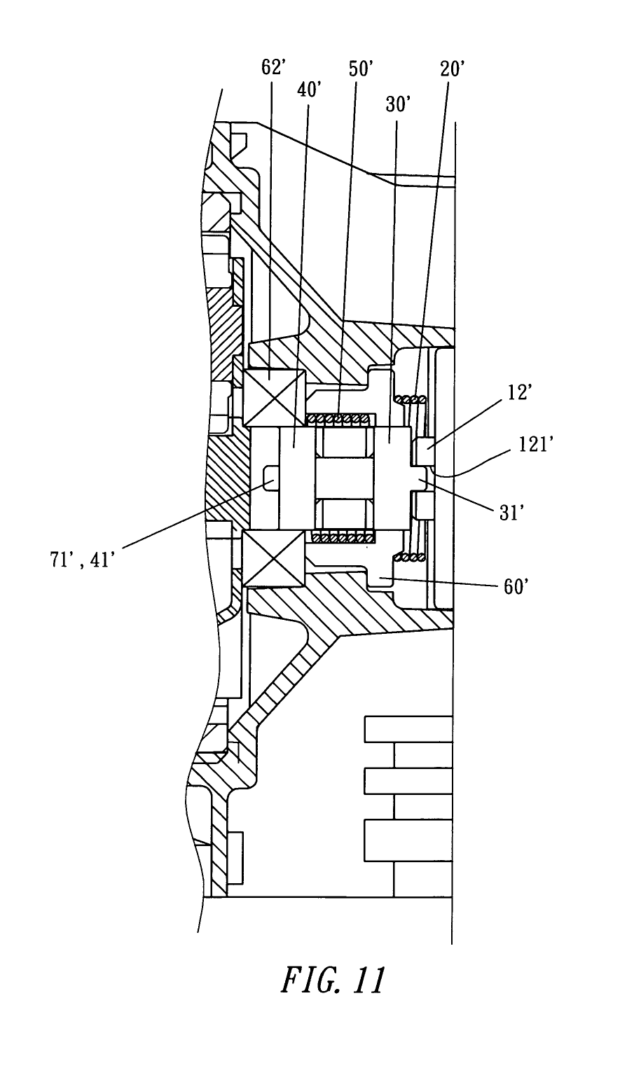

The operating process of the braking device in the third preferred embodiment is the same as that of the braking device in the first preferred embodiment. When the motor 10′ is started to rotate clockwise or counterclockwise, the elastic wires of the braking spring 50′ will be forced to shrink inward, as shown in FIG. 10, and there will form a gap between the inner wall of the holding member 60′ and the braking spring 50. At this time, the braking device fails to carry out braking and hence heavy loads can be slung up or lowered down smoothly. When the motor 10′ is electrically disconnected (either by pressing a stop key or due to unexpected electric stoppage.), the elastic wires of the braking spring 50′ will be forced to expand outward, as shown in FIG. 11, and promptly contact with the inner annular wall of the holding member 60′ and produce frictional function to carry out braking.

Specifically, the braking device for a power winch of this invention is disposed in the transmission course of the power winch and received in the cable drum, that is, positioned between the motor 10 and the spindle 50 as described in the first and the second preferred embodiment, or assembled between the motor 10′ and the reduction gear set 70′ as described in the third preferred embodiment. By so designing, the braking device of this invention can function to brake the power winch promptly.

While the preferred embodiments of the invention have been described above, it will b e recognized and understood that various modifications may be made therein and the appended claims are intended to cover all such modifications that may fall within the spirit and scope of the invention.

1. A braking device to be assembled in the transmission course of a power winch, said device comprising:
a first driving block having one side secured thereon with two symmetrical posts extending outward vertically, said two posts having their outer ends respectively formed with a stepped notch, two accommodating spaces formed between said two posts;
a second driving block having one side disposed thereon with two symmetrical posts extending outward vertically, said two posts having their outer ends respectively cut with a stepped notch, two accommodating spaces formed between said two posts;
a braking spring fitted around the outer circumference of said four posts of said first driving block and second driving block, said braking spring having its opposite ends respectively formed with a hook end bent inward and having an angular difference formed between them, said two hook ends of said braking spring able to be respectively and optionally moved in said stepped notches of said posts of said first and said second driving block, said hook ends of said braking spring driven by said first driving block or by said second driving block to force the elastic wires of said braking spring to shrink inward or expand outward; and
Said braking spring having its elastic wires pushed to shrink inward by said first driving block or by said second driving block when the motor of said braking device is started to rotate clockwise or counterclockwise, at this time, said braking device failing to carry out braking so that heavy loads can be slung up or lowered down smoothly, said braking spring having its spring wires pushed to expand outward by said first driving block or by said second driving block when said motor is electrically disconnected, said device thus able to promptly carry out braking.

2. The braking device for a power winch as claimed in claim 1, wherein said braking device is installed in the interior of a cable drum of a power winch.

3. The braking device for a power winch as claimed in claim 2, wherein an abrasion-resistant bushing ring is firmly fixed on the inner annular wall of said cable drum and positioned at the connecting portion of said first and said second driving block.

4. The braking device for a power winch as claimed in claim 1, wherein said braking device is disposed between said motor and a reduction gear set.

5. The braking device for a power winch as claimed in claim 4, wherein said braking device is provided with a holding member, and said braking spring is fitted in said holding member, said holding member having its front end held in position by a compression spring.
